(19) United States
(12) Patent Application Publication
(10) Pub. No.: US 2025/0178019 A1
(43) Pub. Date: Jun. 5, 2025

(54) DIE

(71) Applicant: HIRANO TECSEED Co., Ltd., Kitakatsuragi-gun, Nara (JP)

(72) Inventor: Yushi Sasano, Kitakatsuragi-gun, Nara (JP)

(73) Assignee: HIRANO TECSEED Co., Ltd., Kitakatsuragi-gun, Nara (JP)

(21) Appl. No.: 18/832,242

(22) PCT Filed: Jan. 27, 2023
(86) PCT No.: PCT/JP2023/002624

§ 371 Date: Jul. 23, 2024

(30) Foreign Application Priority Data
Feb. 15, 2022 (JP) 2022-021520

(51) Int. Cl. B05C 5/02

(52) U.S. Cl. CPC B05C 5/027

(57) ABSTRACT

A liquid reservoir portion 38 in which coating liquid is accumulated is formed in a right-left direction in an upper surface 18 of a first body 112 of a die 10. A shim 16 has a back piece 46 arranged on the upper surface 18 in back of the liquid reservoir portion 38, both right and left pieces 48, 50 arranged on the upper surface 18 on both right and left sides of the liquid reservoir portion 38, and a plurality of comb tooth pieces 52 arranged on the upper surface 18 in front of the liquid reservoir portion 38 and extending in a front-back direction. The plurality of comb tooth pieces 52 are fixed to the upper surface 18 positioned in front of the liquid reservoir portion 38 at predetermined intervals.

### TECHNICAL FIELD

The present invention relates to a die used for a coating apparatus for a web.

### BACKGROUND ART

Conventionally, there has been proposed a coating apparatus having a die for performing stripe coating on an elongated web with coating liquid. Such stripe coating is a coating method in which a comb-shaped shim is assembled with the die and an uncoated portion, a coated portion, an uncoated portion, a coated portion, and an uncoated portion are alternately formed along the width direction of the web.

### CITATION LIST

### Patent Literature

PTL 1: JP2020-28839A
PTL 2: JP2017-35668A

### SUMMARY OF INVENTION

### Technical Problem

Recently, in a case of performing the stripe coating, a coating position is extremely important, and high accuracy is required therefor.

However, the comb-shaped shim is made of metal, and is produced extremely thin and highly accurately with a flat shape. For this reason, there have been problems that distortion cannot be fully eliminated, it is difficult to position each comb tooth due to such distortion upon assembly with the die, and it is difficult to implement intended stripe coating with favorable accuracy.

Thus, the present invention is intended to provide a die configured so that a plurality of comb tooth pieces can be fixed to predetermined positions in a case of assembling a comb-shaped shim with the die.

### Solution to Problem

The present invention relates to a die for performing stripe coating on a web, the die including a first body which is a quadrangular prism long in a right-left direction and has an upper surface formed as a flat surface and is configured such that in the sectional shape thereof in the lateral direction, a front portion of a lower surface is formed so as to be narrowed toward the front, a second body which is a quadrangular prism long in the right-left direction and has a lower surface formed as a flat surface and is configured such that in the sectional shape thereof in the lateral direction, a front portion of an upper surface is formed so as to be narrowed toward the front, and a shim sandwiched between the upper surface of the first body and the lower surface of the second body. A liquid reservoir portion in which coating liquid is accumulated is formed in the right-left direction in the upper surface of the first body. The shim has a back piece arranged on the upper surface in back of the liquid reservoir portion, both right and left pieces arranged on the upper surface on both right and left sides of the liquid reservoir portion, and a plurality of comb tooth pieces arranged on the upper surface in front of the liquid reservoir portion and extending in a front-back direction. The plurality of comb tooth pieces are fixed to the upper surface positioned in front of the liquid reservoir portion, at predetermined intervals.

Moreover, the present invention relates to a die for performing stripe coating on a web, the die including a first body which is a quadrangular prism long in a right-left direction and has a back surface formed as a flat surface and is configured such that in the sectional shape thereof in the lateral direction, an upper portion of a front surface is formed so as to be narrowed toward above, a second body which is a quadrangular prism long in the right-left direction and has a front surface formed as a flat surface and is configured such that in the sectional shape thereof in the lateral direction, an upper portion of a back surface is formed so as to be narrowed toward above, and a shim sandwiched between the back surface of the first body and the front surface of the second body. A liquid reservoir portion in which coating liquid is accumulated is formed in the right-left direction in the back surface of the first body. The shim has a lower piece arranged on the back surface below the liquid reservoir portion, both right and left pieces arranged on the back surface on both right and left sides of the liquid reservoir portion, and a plurality of comb tooth pieces arranged on the back surface above the liquid reservoir portion and extending in an up-down direction. The plurality of comb tooth pieces are fixed to the back surface positioned above the liquid reservoir portion at predetermined intervals.

Further, the present invention relates to a die for performing stripe coating on a web, the die including first body which is a quadrangular prism long in a right-left direction and has an upper surface formed as a flat surface and is configured such that in the sectional shape thereof in the lateral direction, a front portion of a lower surface is formed so as to be narrowed toward front, a second body which is a triangular prism long in the right-left direction and has upper and lower surfaces formed as flat surfaces and is configured such that in the sectional shape thereof in the lateral direction, a front portion is formed so as to be narrowed toward the front, a third body which is a quadrangular prism long in the right-left direction and has a lower surface formed as a flat surface and is configured such that in the sectional shape thereof in the lateral direction, a front portion of an upper surface is formed so as to be narrowed toward the front, a first shim sandwiched between the upper surface of the first body and the lower surface of the second body, and a second shim sandwiched between the upper surface of the second body and the lower surface of the third body. A first liquid reservoir portion in which coating liquid is accumulated is formed in the right-left direction in the upper surface of the first body. A second liquid reservoir portion in which coating liquid is accumulated is formed in the right-left direction in the upper surface of the second body. The first shim has a first back piece arranged on the upper surface in back of the first liquid reservoir portion, both first right and left pieces arranged on the upper surface on both right and left sides of the first liquid reservoir portion, and a plurality of first comb tooth pieces arranged on the upper surface in front of the first liquid reservoir portion and extending in a front-back direction. The plurality of first comb tooth pieces are fixed to the upper surface positioned in front of the first liquid reservoir portion at predetermined intervals. The second shim has a second back piece arranged on the upper surface in back of the second liquid reservoir portion, both second right and left pieces arranged on the upper surface on both right and left sides of the second liquid reservoir portion, and a plurality of second comb tooth pieces arranged on the upper surface in front of the second liquid reservoir portion and extending in the front-back direction. The plurality of second comb tooth pieces are fixed to the upper surface positioned in front of the second liquid reservoir portion at predetermined intervals.

### Advantageous Effects of Invention

According to the present invention, the plurality of comb tooth pieces of the shim are fixed to the upper surface positioned in front of the liquid reservoir portion at the predetermined intervals, and therefore, the positions of coated portions are not displaced in a case of performing the stripe coating.

Moreover, according to the present invention, the plurality of comb tooth pieces of the shim are fixed to the back surface positioned above the liquid reservoir portion at the predetermined intervals, and therefore, the positions of the coated portions are not displaced in a case of performing the stripe coating.

### BRIEF DESCRIPTION OF DRAWINGS

FIG. 1 is a view of the entirety of a coating apparatus of Embodiment 1.

FIG. 2 is a plan view in a state in which coated portions and uncoated portions are formed in a web.

FIG. 3 is an exploded perspective view of a die.

FIG. 4 is a partial perspective view in a state in which comb tooth pieces are about to be fitted in fitting grooves in a land surface.

FIG. 5 is a partially-enlarged perspective view in a state in which the comb tooth pieces are fixed to the fitting grooves in the land surface.

FIG. 6 is a perspective view in a state in which a first body, a shim, and a second body are joined with bolts.

FIG. 7 is a partially-enlarged perspective view in a state in which the first body, the comb tooth pieces of the shim, and the second body are combined together,

FIG. 8 is an exploded perspective view of a die of Embodiment 2.

FIG. 9 is a partially-enlarged perspective view in a state in which comb tooth pieces are about to be attached to pins in a land surface.

FIG. 10 is a partially-enlarged perspective view in a state in which the comb tooth pieces are attached to the pins in the land surface.

FIG. 11 is a perspective view in a state in which the comb tooth pieces are attached to the land surface.

FIG. 12 is a partially-enlarged perspective view in a state in which a first body, the comb tooth pieces, and a second body are attached to each other.

FIG. 13 is a partially-enlarged longitudinal sectional view of the first body, the comb tooth pieces, the second body, and the pin.

FIG. 14 is an exploded perspective view of a die of Embodiment 3.

FIG. 15 is a view of the entirety of a coating apparatus of Embodiment 4.

FIG. 16 is a view of the entirety of a coating apparatus of Embodiment 5.

### DESCRIPTION OF EMBODIMENTS

A coating apparatus 1 that performs stripe coating on a web W according to one embodiment of the present invention will be described with reference to the drawings. The elongated web W includes, e.g., metal foil, a film, mesh-shaped metal, paper, and fabric.

### Embodiment 1

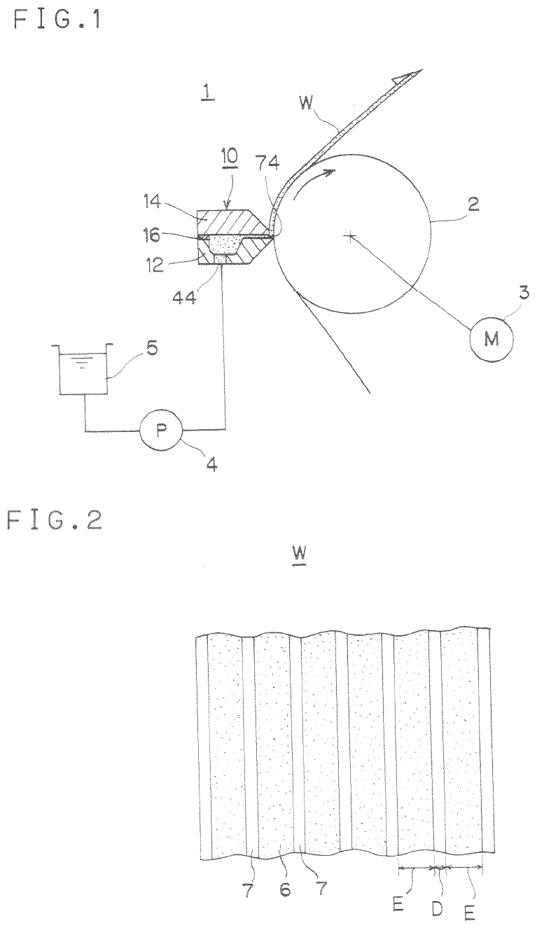

A coating apparatus 1 of Embodiment 1 will be described with reference to FIGS. 1 to 7.

### (1) Coating Apparatus 1

The structure of the coating apparatus 1 will be described with reference to FIGS. 1 and 2.

As shown in FIG. 1, the coating apparatus 1 has a backing-up roll 2 rotated at a certain rotation speed by a motor 3, a pump 4, a coating liquid tank 5, and a die 10.

The backing-up roll 2 runs the web W upwardly from below at a certain speed while holding the web W. The die 10 is arranged in the horizontal direction (horizontal posture) in back of the backing-up roll 2. The pump 4 pumps coating liquid accumulated in the tank 5 to the die 10, and the die 10 performs the stripe coating on the web W with the coating liquid from discharge ports 74 at a front end portion of the die 10. In this manner, coated portions 6 and uncoated portions 7 are alternately formed in the web W as shown in FIG. 2.

### (2) Die 10

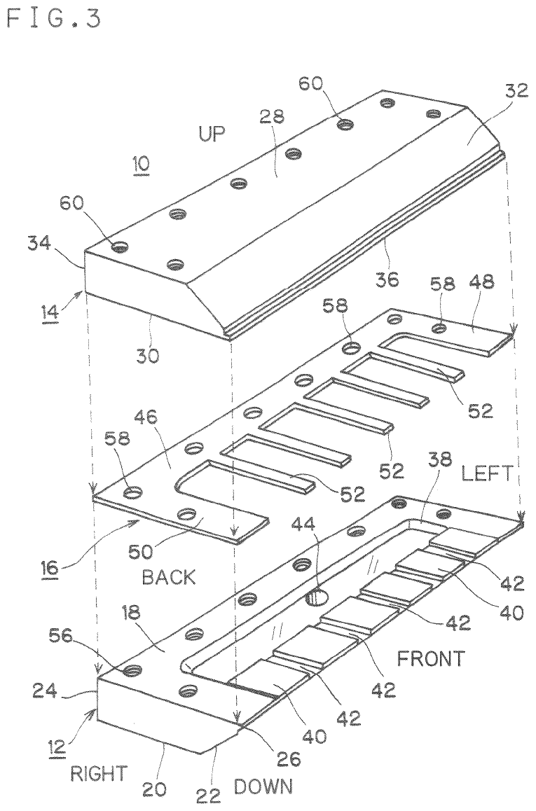

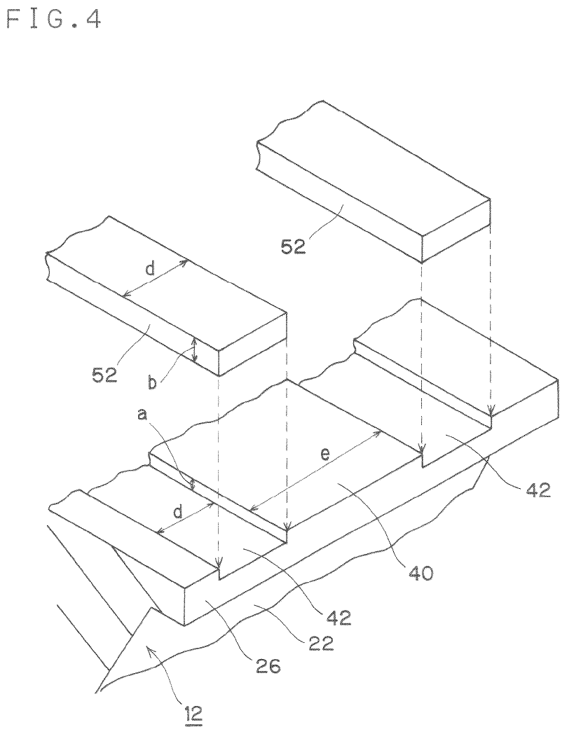

Next, the die 10 that performs the stripe coating will be described with reference to FIGS. 3 to 7. Note that in description below, a right-left direction means the width direction of the web W and the backing-up roll 2 is in front of the die 10 in FIG. 1 in a front-back direction. The die 10 has a first body 12, a second body 14, and a shim 16 as shown in FIG. 3.

### (2-1) First Body 12

The first body 12 will be described. As shown in FIG. 3, the first body 12 is a quadrangular prism long in the right-left direction, and has an upper surface 18 formed as a horizontal flat surface. A lower surface 20 is formed as a horizontal flat surface. A lower inclined surface 22 is formed continuously to a front end portion of the lower surface 20. The lower inclined surface 22 is formed so as to be narrowed toward the front in the sectional shape of the first body 12 in the lateral direction thereof. The first body 12 has a back surface 24 formed as a vertical flat surface. The first body 12 has both right and left surfaces formed as vertical flat surfaces.

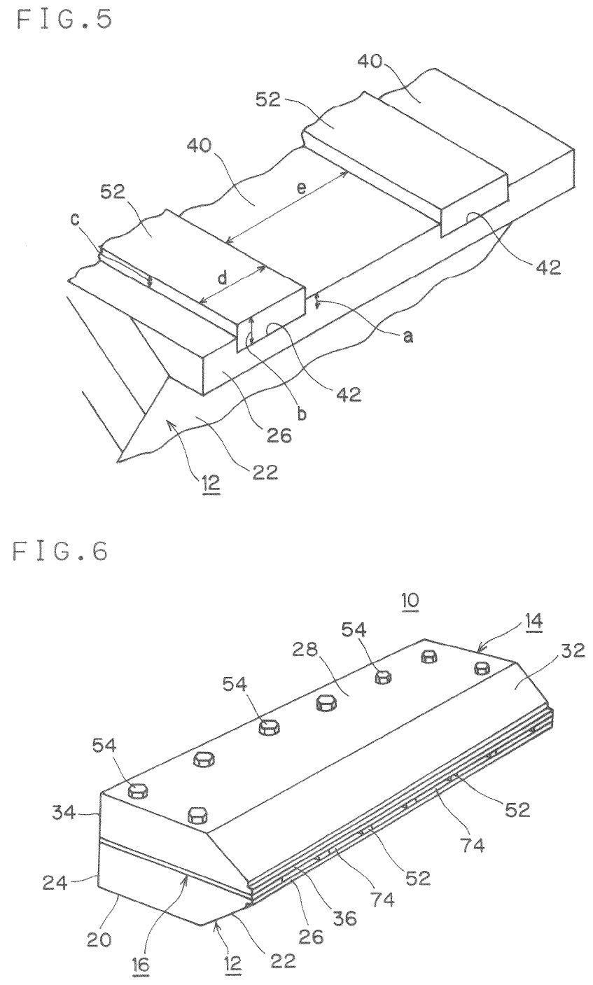

As shown in FIGS. 4 and 5, a lower lip portion 26 is formed at a position at which a front end portion of the upper surface 18 and a front end portion of the lower inclined surface 22 cross each other in the first body 12. The lower lip portion 26 is a rectangular parallelepiped long in the right-left direction, and has a front surface formed as a vertical flat surface. Moreover, the lower lip portion 26 is in the shape of a lip protruding forward from the front end portion of the first body 12.

As shown in FIG. 3, a liquid reservoir portion 38 long in the right-left direction is formed in the upper surface 18 of the first body 12. The liquid reservoir portion 38 has a rectangular planar shape, and is provided in a center portion of the upper surface 18 of the first body 12, A supply port 44 to which the coating liquid is supplied is formed in the bottom at a center portion of the liquid reservoir portion 38 in the right-left direction, and penetrates the lower surface 20.

As shown in FIG. 3, the upper surface 18 positioned in front of the liquid reservoir portion 38 and the upper surface of the lower lip portion 26 will be collectively referred to as a “land surface” 40 in the present specification. As shown in FIG. 4, n (n=>1, five in FIGS. 3 and 6) fitting grooves 42 extending in the front-back direction are formed at predetermined intervals e in the land surface 40. The depth dimension of the fitting groove 42 is a. On the other hand, the land surface 40 is formed higher than the upper surface 18 (upper surface 28 on which a left piece 48 and a right piece 50 of the shim 16 are arranged as described later) on both right and left sides of the land surface 40 by the dimension a. The width d of the fitting groove 42 will be described later.

As shown in FIG. 3, a plurality of bolt holes 56 penetrates the first body 12 in an up-down direction at positions at the outer periphery of the liquid reservoir portion 38.

### (2-2) Second Body 14

The second body 14 will be described. As shown in FIG. 3, the second body 14 is a quadrangular prism long in the right-left direction, and is formed with the same dimension as that of the first body 12 in the right-left direction. The second body 14 has a lower surface 30 formed as a horizontal flat surface. The upper surface 28 is also formed as a horizontal flat surface. An upper inclined surface 32 is formed continuously to a front end portion of the upper surface 28. The upper inclined surface 32 is formed so as to be narrowed toward the front in the sectional shape of the second body 14 in the lateral direction thereof. The second body 14 has a back surface 34 formed as a flat surface. The second body 14 has both right and left surfaces formed as flat surfaces.

An upper lip portion 36 is formed at a position at which the upper inclined surface 32 and the lower surface 30 cross each other. The upper lip portion 36 is a rectangular parallelepiped long in the right-left direction, and has a front surface formed as a vertical flat surface. Moreover, the upper lip portion 36 is in the shape of a Lip protruding forward from a front end portion of the second body 14.

A plurality of bolt holes 60 penetrates the second body 14 in the up-down direction at positions corresponding to the positions of the plurality of bolt holes 56 of the first body 12.

### (2-3) Shim 16

The shim 16 will be described. As shown in FIGS. 3 and 4, the shim 16 is in a comb shape and is formed of a thin metal plate with a thickness dimension b (note that b>a), and a back piece 46, the left piece 48, the right piece 50, and comb tooth pieces 52 are integrally formed. The back piece 46 has a rectangular planar shape, and is arranged on the upper surface 18 in back of the liquid reservoir portion 38. The left piece 48 has a rectangular planar shape, extends forward from a left end portion of the back piece 46, and is arranged on the upper surface on the left side of the liquid reservoir portion 38. The right piece 50 has a rectangular planar shape, extends forward from a right end portion of the back piece 46, and is arranged on the upper surface 18 on the right side of the liquid reservoir portion 38. The comb tooth piece 52 has a rectangular planar shape, and n (n=>1, five in FIGS. 3 and 6) comb tooth pieces 52 protrude forward from a front end portion of the back piece 46 between the left piece 48 and the right piece 50 at the predetermined intervals e.

As shown in FIG. 4, the comb tooth pieces 52 each protrude at positions corresponding to the plurality of fitting grooves 42 provided in the land surface 40, and the width d of the comb tooth piece 52 is the substantially same dimension as the width d of the fitting groove. Thus, as shown in FIGS. 4 and 5, the comb tooth piece 52 can be fitted in the fitting groove 42. As shown in FIGS. 2 and 5, the comb tooth piece 52 is formed with such a length that a front end portion thereof is coincident with a front end portion of the fitting groove 42, i.e., a front end portion of the lower lip portion 26.

In a case of performing the stripe coating by the die 10, the position of the comb tooth piece 52 corresponds to the position of the uncoated portion 7 of the web W, and a portion between adjacent ones of the comb tooth pieces 52, 52 corresponds to the position of the coated portion 6. A width D of each of the six uncoated portions 7 and a width E of the uncoated portion 7 in the web W as shown in FIG. 2 are known, but actually, the width D of the uncoated portion 7 and the width d of the fitting groove are not fully coincident with each other and the width E of the coated portion 6 and the interval e between adjacent ones of the comb tooth pieces 52, 52 are not fully coincident with each other. For this reason, experiment is conducted in advance to obtain the width d of the comb tooth piece 52 and the interval e between the comb tooth pieces 52, 52 in order to obtain the width D of the uncoated portion 7 and the width E of the coated portion 6. The fitting grooves 42 are formed in the land surface 40 accordingly.

A plurality of bolt holes 58 penetrates the shim 16 at positions corresponding to the positions of the plurality of bolt holes 56 of the first body 12.

### (3) Method for Assembling Die 10

Next, a method for assembling the die 10 will be described with reference to FIGS. 2 to 7.

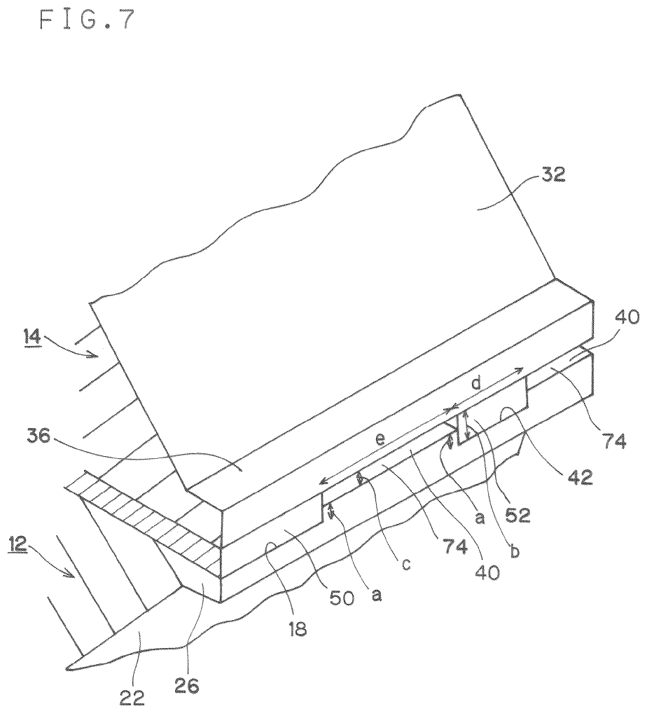

First, as shown in FIGS. 3 to 5, the shim 16 is assembled with the upper surface 18 of the first body 12. In this case, the back piece 46 of the shim 16 is arranged on the upper surface 18 in back of the liquid reservoir portion 38, the left piece 48 is arranged on the upper surface 18 on the left side of the liquid reservoir portion 38, the right piece 50 is arranged on the upper surface 18 on the right side of the liquid reservoir portion 38, and the comb tooth pieces 52 are each fitted in the fitting grooves 42. Note that as shown in FIG. 7, the land surface 40 is formed higher than the upper surface 18 on both right and left sides of the land surface 40 by the height a, and therefore, even when the comb tooth pieces 52 are fitted in the fitting grooves 42 in the land surface 40, is at the same height as those of the back piece 46, left piece 48, and right piece 50 of the shim 16 arranged on the first body 12.

Secondly, as shown in FIGS. 6 and 7, the second body 14 are arranged on the first body 12 and the shim 16, and these components are integrally fastened with a plurality of bolts 54. Note that the plurality of bolts 54 are fastened with screwed into the plurality of bolt holes 60 of the second body 14, the plurality of bolt holes 58 of the shim 16, and the plurality of bolt holes 56 of the first body 12 in this order. Then, the lower lip portion 26 of the front end portion of the first body 12 and the upper lip portion 36 of the front end portion of the second body 14 form a lip portion in the shape of a lip protruding from the front end portion of the die 10. The discharge port 74 is formed between the comb tooth piece 52 and the comb tooth piece 52 of such a lip portion, and a dimension c of the discharge port 74 in the up-down direction is c=b−a. Then, the coating liquid is discharged through these discharge ports 74, and in this manner, the stripe coating can be performed.

### (4) Operation State of Coating Apparatus 1

Next, an operation state of the coating apparatus 1 will be described with reference to FIGS. 1, 2, and 7.

As shown in FIG. 1, the backing-up roll 2 is rotated at the certain rotation speed by the motor 3, and runs the web W upwardly from below at the certain speed while holding the web W at the back peripheral surface thereof. The pump 4 pumps the coating liquid accumulated in the tank 5 to the supply port 44 of the die 10. The coating liquid pumped to the die 10 spreads right and left in the liquid reservoir portion 38, and passes between adjacent ones of the comb tooth pieces 52 (liquid path). The web W is coated with the coating liquid from the discharge ports 74 in the front surface of the lip portion, and in this manner, the stripe-shaped coated portions 6 are formed. On the other hand, no coating liquid is applied to the positions of the comb tooth pieces 52, and the uncoated portions 7 are formed accordingly. As a result, as shown in FIG. 2, the stripe coating can be performed such that the coated portions 6 with the width E and the uncoated portions 7 with the width D are alternately formed in the web W.

### (5) Effects

According to the present embodiment, the width d of the comb tooth piece 52 of the shim 16 and the interval e between adjacent ones of the comb tooth pieces 52, 52 in the land surface 40 are formed corresponding to the width D of the uncoated portion 7 and the width E of the coated portion 6 in the web W, and the comb tooth pieces 52 are fitted in the fitting grooves 42. Thus, the coated portions 6 and the uncoated portions 7 can be formed with the width dimensions with high accuracy as designed in the web W without position displacement of the comb tooth piece 52 during assembly of the die 10 and coating by the die 10.

### (6) Modifications

In the above-described embodiment, the back piece 46, both right and left pieces 48, 50, and plurality of comb tooth pieces 52 of the shim 16 are integrated, but only the plurality of comb tooth pieces 52 may be separated from the back piece 46 and the both right and left pieces 48, 50.

In the above-described embodiment, the supply port 44 extending from the liquid reservoir portion 38 penetrates the lower surface 20, but the present invention is not limited thereto and the supply port 44 may penetrate the back surface of the first body 12.

### Embodiment 2

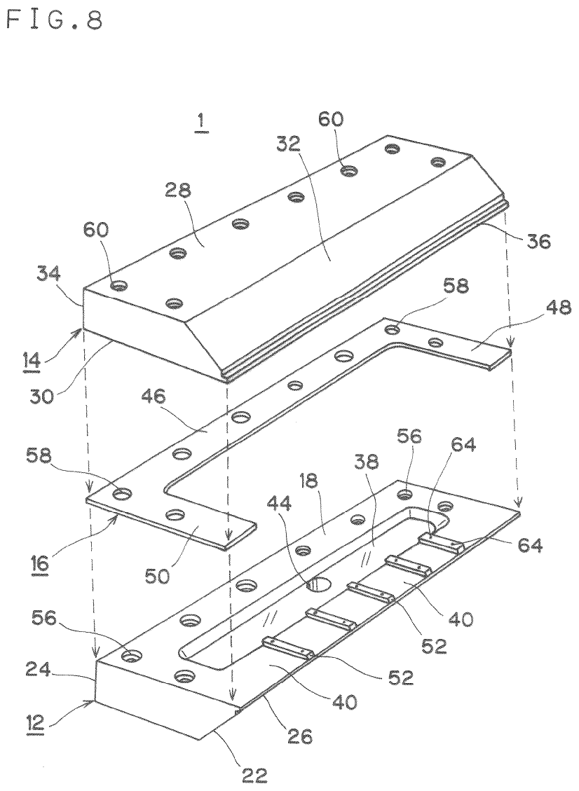

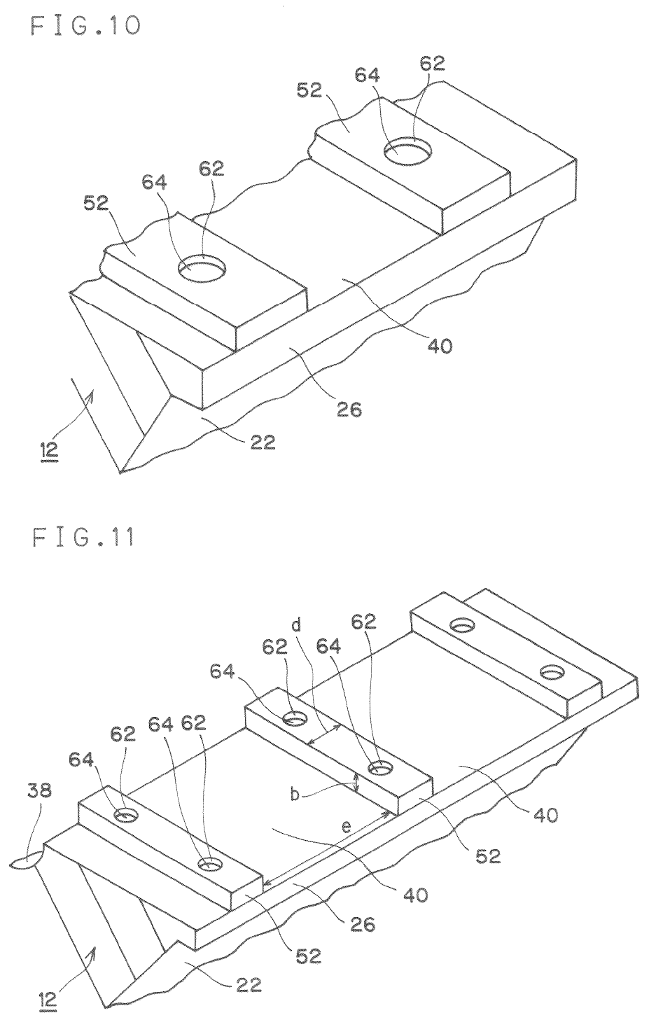

Next, a die 10 of a coating apparatus 1 of Embodiment 2 will be described with reference to FIGS. 8 to 13. Differences between the present embodiment and Embodiment 1 are the structure of a comb tooth piece 52 of a shim 16 with a thickness dimension b and the structure of a land surface 40.

In Embodiment 1, the comb tooth pieces 52 of the comb-shaped shim 16 are integrated with the back piece 46, but in the present embodiment, the comb tooth pieces 52 are independently separated from the back piece 46 as shown in FIGS. 8 and 11. As shown in FIG. 8, the comb tooth piece 52 is formed of a rectangular metal plate, and the width of the comb tooth piece 52 is a dimension d corresponding to the width D of the uncoated portion 7. Moreover, the length of the comb tooth piece 52 in the front-back direction is the same dimension as the length of the land surface 40 in the front-back direction. Two pin holes 62 penetrate the comb tooth piece 52 in the up-down direction, and are opened in front and back portions of the rectangular comb tooth piece 52 in plan view. Note that unlike Embodiment 1, the land surface 40 of the present embodiment is formed at the same height as that of the upper surface 28 on which the left piece 48 and right piece 50 of the shim 16 are arranged.

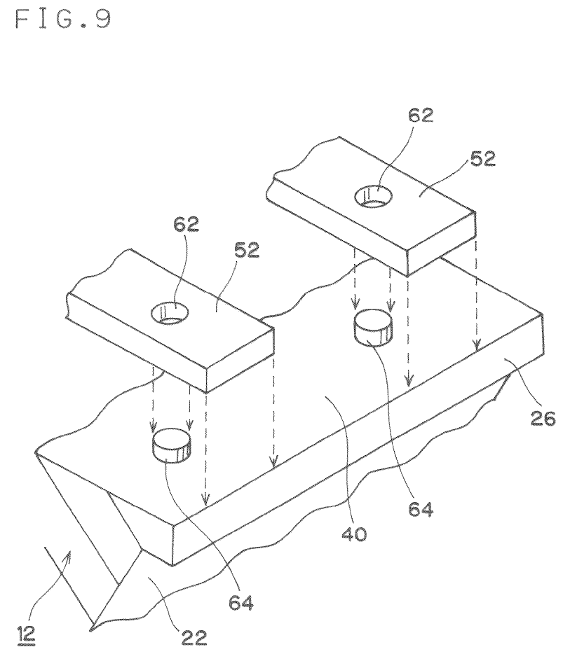

Pins 64 protrude from the land surface 40 at positions to which the comb tooth pieces 52 are attached, as shown in FIG. 9. The pins 64 are positioned so as to be embedded in the land surface 40 in advance as shown in FIG. 13 such that the interval e between adjacent ones of the comb tooth pieces 52 corresponds to the width E of the coated portion 6 of the web W as shown in FIG. 11. Moreover, as shown in FIG. 11, two pins 64 in the front-back direction protrude corresponding to two pin holes 62, 62 of the comb tooth piece 52. These pins 64 are protrusions protruding from the land surface 40.

In a case where the shim 16 is assembled with the upper surface of the first body 12, the back piece 46 of the shim 16 is arranged on the upper surface 18 in back of the liquid reservoir portion 38, the left piece 48 is arranged on the upper surface 18 on the left side of the liquid reservoir portion 38, and the right piece 50 is arranged on the upper surface 18 on the right side of the liquid reservoir portion 38, as shown in FIG. 8. Moreover, as shown in FIGS. 8 and 11, the independent comb tooth pieces 52 are each attached to the positions at which the pins 64 protrude.

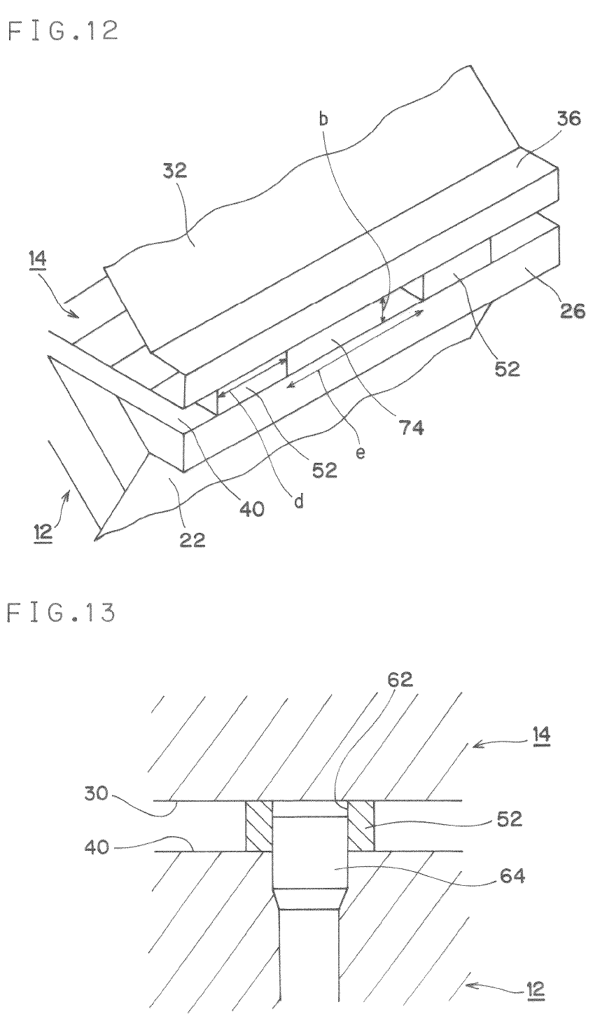

After the shim 16 and the plurality of comb tooth pieces 52 have been attached in this manner, the second body 14 is arranged from above and is fixed with a plurality of bolts, as shown in FIG. 12. Note that the plurality of bolts are fastened with screwed into the plurality of bolt holes 60 of the second body 14, the plurality of bolt holes 58 of the shim 16, and the plurality of bolt holes 56 of the first body 12 in this order. Then, as shown in FIG. 12, the lower lip portion 26 of the front end portion of the first body 12 and the upper lip portion 36 of the front end portion of the second body 14 form the lip portion in the shape of the lip protruding from the front end portion of the die 10. The discharge port 74 is formed between the comb tooth piece 52 and the comb tooth piece 52 of such a lip portion, and the dimension of the discharge port 74 in the up-down direction is the same dimension as the thickness b of the shim 16. Then, the coating liquid is discharged through these discharge ports 74, and in this manner, the stripe coating can be performed.

In the die 10 of the present embodiment, the pins 64 are provided, in the land surface 40, corresponding to the uncoated portions 7 of the web W, and the comb tooth pieces 52 are fixed to the pins 64. Thus, the stripe coating can be performed such that the coated portions 6 and the uncoated portions 7 are formed with high accuracy in the web W.

In the above-described embodiment, the two pins 64 in the front-back direction are provided in the land surface 40, but the number of pins 64 to be provided and the positions thereof are not limited thereto. For example, three pins 64 may be arranged at the positions of the vertices of an isosceles triangle in plan view, and corresponding thereto, three pin holes 62 may also be provided in the comb tooth piece 52.

In the above-described embodiment, the pin holes 62 are opened so as to penetrate the comb tooth piece 52, but instead, recesses may be counterbored in the lower surface of the comb tooth piece 52 to such an extent that the pins 64 can be housed in the recesses.

In the above-described embodiment, the pin 64 is used as the protrusion protruding from the land surface, but instead, other members such as screws may be used.

### Embodiment 3

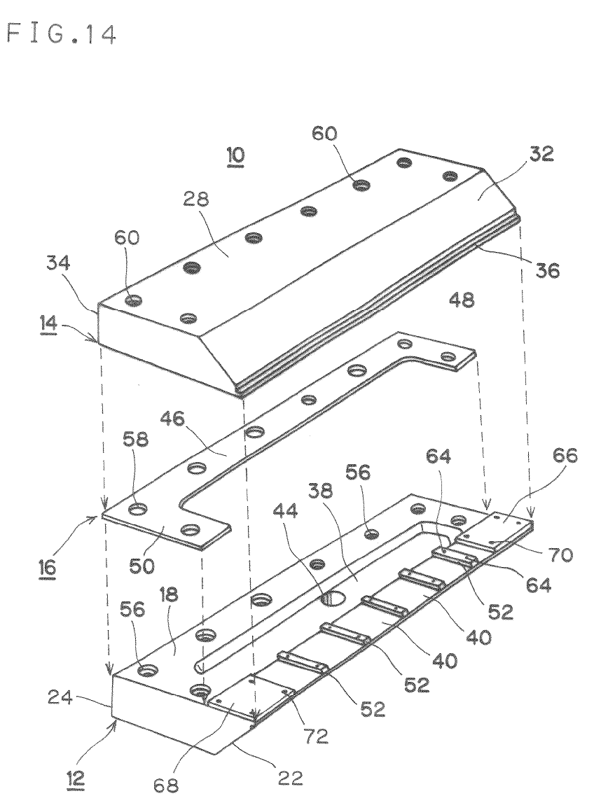

Next, a die 10 of a coating apparatus 1 of Embodiment 3 will be described with reference to FIG. 14.

In Embodiment 2, only the comb tooth pieces $2 are independent from the back piece 46, the left piece 48, and the right piece 50 of the shim 16. Instead, in the present embodiment, each of the left piece 48 and the right piece 50 is divided into two pieces.

As shown in FIG. 14, a front end portion of the left piece 48 extends to a front end portion of the liquid reservoir portion 38, and a left front shim piece 66 separated from the left piece 48 and having a rectangular planar shape is arranged at a left end portion of the land surface 40 in front of the left piece 48.

As shown in FIG. 14, a front end portion of the right piece 50 also extends to the front end portion of the liquid reservoir portion 38, and a right front shim piece 68 separated from the right piece 50 and having a rectangular planar shape is arranged at a right end portion of the land surface 40 in front of the right piece 50.

As shown in FIG. 14, four pin holes penetrate the left front shim piece 66 at positions inside the corners thereof, and four pins 70 protrude from the left end portion of the land surface 40. The pin holes of the left front shim piece 66 are fitted onto these four pins 70, and in this manner, the left front shim piece 66 can be positioned on and fixed to the land surface 40.

As shown in FIG. 14, four pin holes penetrate the right front shim piece 68 at positions inside the corners thereof, and four pins 72 protrude from the right end portion of the land surface 40. The pin holes of the right front shim piece 68 are fitted onto these four pins 72, and in this manner, the right front shim piece 68 can be positioned on and fixed to the land surface 40.

Also in the present embodiment, the comb tooth pieces 52 of the comb-shaped shim 16, the left front shim piece 66, and the right front shim piece 68 can be easily attached corresponding to the uncoated portions 7 and the coated portions 6 of the web W.

### Embodiment 4

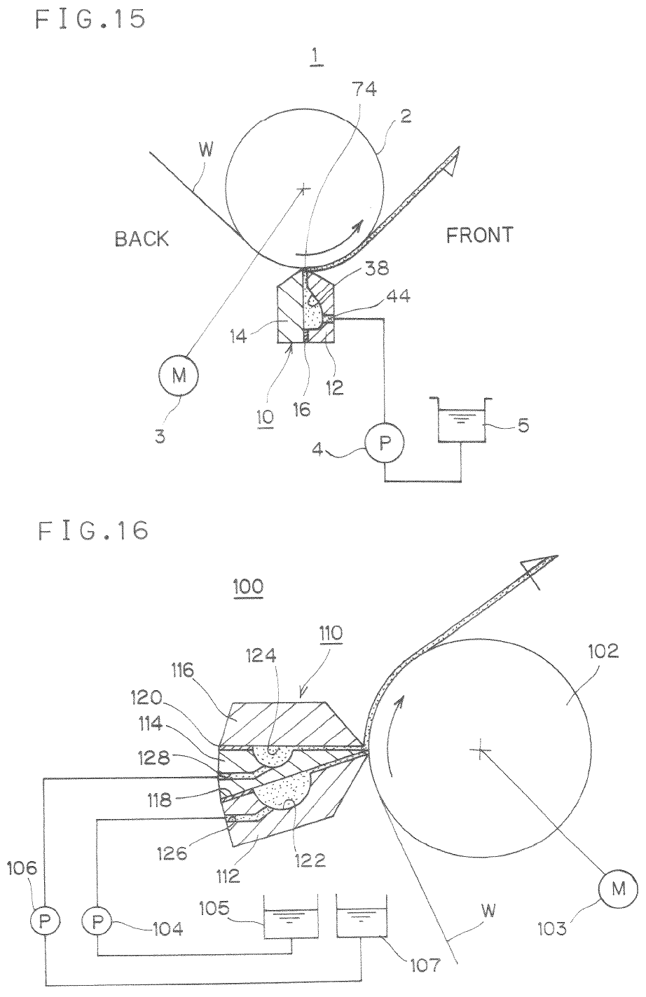

Next, a coating apparatus 1 of Embodiment 4 will be described with reference to FIG. 15.

In Embodiments 1 to 3 above, the die 10 is arranged in the horizontal direction (horizontal posture) in back of the backing-up roll 2. Instead, in the present embodiment, the die 10 is arranged in the vertical direction (vertical posture) below the backing-up roll 2.

As shown in FIG. 15, the backing-up roll. 2 runs the web W in the front-back direction at the certain speed while holding the web W at the lower peripheral surface thereof. The die 10 is arranged in the vertical posture below such a backing-up roll 2. The pump 4 pumps the coating liquid accumulated in the tank 5 to the die 10, and the die 10 performs the stripe coating on the web W with the coating liquid from the discharge ports 74 at an upper end portion of the die 10.

The die 10 of the present embodiment also includes the first body 12, the second body 14, and the shim 16, and is arranged in the vertical direction (longitudinal direction) with rotated 90° from the die 10 in the horizontal direction (lateral direction) in Embodiment 1.

That is, the first body 12 of the die 10 is a quadrangular prism long in the right-left direction and has a back surface formed as a flat surface, and in the sectional shape thereof in the lateral direction, an upper portion of a front surface has a front inclined surface formed so as to be narrowed toward above. The liquid reservoir portion 38 in which the coating liquid is accumulated is formed in the right-left direction in the back surface of the first body 12.

The second body 14 is a quadrangular prism long in the right-left direction and has a front surface formed as a flat surface, and in the sectional shape thereof in the lateral direction, an upper portion of a back surface has a back inclined surface formed so as to be narrowed toward above.

The comb-shaped shim 16 is sandwiched between the back surface of the first body 12 and the front surface of the second body 14. The shim 16 has a lower piece arranged on the back surface of the first body 12 below the liquid reservoir portion 38, both right and left pieces arranged on the back surface of the first body 12 on both right and left sides of the liquid reservoir portion 38, and a plurality of comb tooth pieces arranged on the front surface (land surface) of the first body 12 above the liquid reservoir portion 38 and extending in the up-down direction from the lower piece.

Fitting grooves are provided in the up-down direction in the land surface of the first body 12, and the plurality of comb tooth pieces of the shim 16 are fixed at predetermined intervals.

Embodiment 4 has such a structure that the die 10 of Embodiment 1 is arranged in the longitudinal direction, but instead, the die 10 of Embodiment 2 may be arranged in the longitudinal direction. Specifically, the shim 16 is configured such that the lower piece and the both right and left pieces are integrated and only the plurality of comb tooth pieces are separated. Moreover, the plurality of comb tooth pieces are fixed to the land surface of the first body 12 with pins at the predetermined intervals.

In Embodiment 4, the die 10 is arranged in the vertical direction (vertical posture) below the backing-up roll 2, but may be arranged diagonally so as to be inclined with respect to the vertical direction. Specifically, the inclination angle θ° of the back surface of the first body 12 and the front surface of the second body 14 with respect to the vertical direction in side view is only required to be 0°<=θ°<=45° or less. Note that the case of θ°=0° is Embodiment 4 and the case of θ°=90° is Embodiments 1 and 2.

The direction of installation of the die 10 is only required to be 0°<=θ°<=90°, and for example, the die may be arranged diagonally with θ°=45°.

### Embodiment 5

Next, a die 110 of a coating apparatus 100 of Embodiment 5 will be described with reference to FIG. 16. Embodiments 1 to 4 relate to the coating apparatus 1 that performs the stripe coating with a single layer of coating liquid, but the coating apparatus 100 of the present embodiment can perform stripe coating by laminating coating liquid in two layers.

### (1) Die 110

First, the die 110 will be described. The die 110 is arranged in the horizontal direction (horizontal posture) in back of a backing-up roll 102. The die 110 has a first body 112, a first shim 118 arranged on the first body 112, a second body 114 arranged on the first shim 118, a second shim 120 arranged on the second body 114, and a third body 116 arranged on the second shim 120.

The first body 112 is a quadrangular prism long in the right-left direction and has an upper surface formed as a flat surface, and in the sectional shape thereof in the lateral direction, a front surface formed continuously from a lower surface is formed so as to be narrowed toward the front. A first liquid reservoir portion 122 is provided in the upper surface of the first body 112, and a first supply port 126 to which first coating liquid is supplied is provided in a center portion of the first liquid reservoir portion 122 in the right-left direction. The first supply port 126 extends to the back surface of the first body 112, and the first coating liquid is supplied from such a back surface.

The second body 114 is a triangular prism long in the right-left direction and has upper and lower surfaces formed as flat surfaces, and in the sectional shape thereof in the lateral direction, a front portion is formed so as to be narrowed toward the front. A second liquid reservoir portion 124 is provided in the upper surface of the second body 114, and a second supply port 128 to which second coating liquid is supplied is also provided in the second liquid reservoir portion 124. The second supply port 128 extends to the back surface of the second body 114, and the second coating liquid is supplied from such a back surface.

The third body 116 is a quadrangular prism long in the right-left direction and has a lower surface formed as a flat surface, and in the sectional shape thereof in the lateral direction, a front surface formed continuously from an upper surface is formed so as to be narrowed toward the front.

The first shim 118 is sandwiched between the upper surface of the first body 112 and the lower surface of the second body 114. The first shim 118 has a first back piece arranged on the upper surface in back of the first liquid reservoir portion 122, both first right and left pieces arranged on the upper surface on both right and left sides of the first liquid reservoir portion 122, and a plurality of first comb tooth pieces protruding from a front end portion of the first back piece at predetermined intervals. First fitting grooves in which the plurality of first comb tooth pieces are fitted and fixed at the predetermined intervals are formed in the upper surface (first land surface) of the first body 112 positioned in front of the first liquid reservoir portion 122.

The second shim 120 is sandwiched between the upper surface of the second body 114 and the lower surface of the third body 116. The second shim 120 has a second back piece arranged on the upper surface in back of the second liquid reservoir portion 124, both second right and left pieces arranged on the upper surface on both right and left sides of the second liquid reservoir portion 124, and a plurality of second comb tooth pieces protruding in the front-back direction from a front end portion of the second back piece at predetermined intervals. Second fitting grooves in which the plurality of second comb tooth pieces are fitted and fixed at the predetermined intervals are formed in the upper surface (second land surface) of the second body 114 positioned in front of the second liquid reservoir portion 124.

### (2) Coating Apparatus 100

The coating apparatus 100 will be described with reference to FIG. 16. The backing-up roll 102 rotated at a certain speed by a motor 103 runs a web W upwardly from below while holding the web W at the back peripheral surface thereof. The die 110 that performs the two-layer stripe coating is arranged in the horizontal direction (horizontal posture) in back of the backing-up roll 102. The first coating liquid to be applied as a first layer is pumped to the first liquid reservoir portion 122 of the die 110 from a first tank 105 by a first pump 104, and the second coating liquid to be applied as a second layer is pumped to the second liquid reservoir portion 132 of the die 110 from a second tank 107 by a second pump 106. The first coating liquid spreads right and left in the first liquid reservoir portion 122, and passes between adjacent ones of the first comb tooth pieces. The web W is coated with the first coating liquid from discharge ports in the front surface of the die 110, and in this manner, first coated portions of the first layer are formed. On the other hand, no first coating liquid is applied to the positions of the first comb tooth pieces, and first uncoated portions are formed accordingly. The second coating liquid spreads right and left in the second liquid reservoir portion 124, and passes between adjacent ones of the second comb tooth pieces. The web W is coated with the second coating liquid from the discharge ports in the front surface of the die 110, and in this manner, second coated portions of the second layer are formed on the first coated portions of the first layer. On the other hand, no second coating liquid is applied to the positions of the second comb tooth pieces, and uncoated portions are formed accordingly.

According to the present embodiment, the first comb tooth pieces of the first shim 118 are each fitted in and fixed to the first fitting grooves provided in the first land surface of the first body 112, and the second comb tooth pieces of the second shim 120 are each fitted in and fixed to the second fitting grooves provided in the second land surface of the second body 114. Thus, the stripe coating can be performed such that the coated portions 6 and the uncoated portions 7 are formed in the two layers with high accuracy in the web W.

### (3) Modification 1

In Embodiment 5 above, the structure of the die 10 of Embodiment 1 is applied, but instead, the structure of the die 10 of Embodiment 2 may be applied in Modification 1, That is, the first comb tooth pieces of the first shim 118 are independently provided, and the second comb tooth pieces of the second shim 120 are independently provided. First pins protrude from the first land surface of the first body 112 at positions corresponding to the positions of the uncoated portions, and second pins also protrude from the second land surface of the second body 114 at positions corresponding to the positions of the uncoated portions. Moreover, the independent first comb tooth pieces and second comb tooth pieces are each fixed to the first pins and the second pins.

### (4) Modification 2

Instead of the above-described embodiments, in Modification 2, the die 110 may be arranged in the vertical direction (vertical posture) below the backing-up roll 102.

### (5) Modification 3

The coating liquid is laminated in the two layers in the stripe coating in the above-described embodiment, but instead, in Modification 3, the stripe coating may be performed on the web W one layer at a time with the positions of the first comb tooth pieces of the first shim and the positions of the second comb tooth pieces of the second shim shifted from each other. In this case, the coating is performed such that the first coated portions with the first coating liquid and the second coated portions with the second coating liquid are alternately arranged with the uncoated portions interposed therebetween.

### Modifications

Next, modifications of the above-described embodiments will be described.

In the above-described embodiments, the lower lip portion 26 and the upper lip portion 36 are provided, but the front end portion of the first body 12 may be configured such that the flat upper surface 18 and the lower inclined surface 22 cross each other and the front end portion of the second body 14 may also be configured such that the flat lower surface 30 and the upper inclined surface 32 cross each other without the lower lip portion 26 and the upper lip portion 36. In this case, the land surface 40 is formed of only the upper surface 18 of the first body 12 in front of the liquid reservoir portion 38.

In the above-described embodiments, all the widths of the coated portions 6 formed in the web W by the stripe coating are the same as each other in the width direction, but the coated portions 6 may be formed with different widths. In this case, the widths of the comb tooth pieces 52 are set corresponding to the different widths of the coated portions 6.

The embodiments of the present invention have been described above, but have been provided as examples and are not intended to limit the scope of the invention. These new embodiments can be implemented in various other forms, and various omissions, replacements, and changes can be made without departing from the gist of the invention. These embodiments and modifications thereof are included in the scope and gist of the invention, and are included in the scopes of the invention described in the claims and the equivalents thereof.

### REFERENCE SIGNS LIST

10: Die
12: First Body
14: Second Body
16: Shim
18: Upper Surface
20: Low
38: Liquid Reservoir Portion
40: Land Surface
42: Fitting Groove
46: Back Piece
48: Left Piece
50: Right Piece
52: Comb Tooth Piece

1. A die for performing stripe coating on a web, comprising:
a first body which is a quadrangular prism long in a right-left direction and has an upper surface formed as a flat surface and is configured such that in a sectional shape thereof in a lateral direction, a front portion of a lower surface is formed so as to be narrowed toward front;
a second body which is a quadrangular prism long in the right-left direction and has a lower surface formed as a flat surface and is configured such that in a sectional shape thereof in a lateral direction, a front portion of an upper surface is formed so as to be narrowed toward the front; and
a shim sandwiched between the upper surface of the first body and the lower surface of the second body,
wherein a liquid reservoir portion in which coating liquid is accumulated is formed in the right-left direction in the upper surface of the first body,
the shim has a back piece arranged on the upper surface in back of the liquid reservoir portion, both right and left pieces arranged on the upper surface on both right and left sides of the liquid reservoir portion, and a plurality of comb tooth pieces arranged on the upper surface in front of the liquid reservoir portion and extending in a front-back direction, and
the plurality of comb tooth pieces are fixed to a land surface, which is the upper surface positioned in front of the liquid reservoir portion, at a predetermined interval.

2. The die according to claim 1, wherein
the plurality of comb tooth pieces are fitted in and fixed to fitting grooves provided in the land surface at a predetermined interval.

3. The die according to claim 1, wherein
protrusions protrude from the land surface at a predetermined interval,
the plurality of comb tooth pieces are formed with holes or recesses, and
the holes or the recesses in the plurality of comb tooth pieces are fitted onto the protrusions, and the plurality of comb tooth piece are fixed to the land surface.

4. The die according to claim 1, wherein
the shim is configured such that the back piece, the both right and left pieces, and the plurality of comb tooth pieces are integrated.

5. The die according to claim 1, wherein
the shim is configured such that the back piece and the both right and left pieces are integrated and the plurality of comb tooth pieces are separated from each other and are also separated from the back piece and the both right and left pieces.

6. A die for performing stripe coating on a web, comprising:
a first body which is a quadrangular prism long in a right-left direction and has a back surface formed as a flat surface and is configured such that in a sectional shape thereof in a lateral direction, an upper portion of a front surface is formed so as to be narrowed toward above;
a second body which is a quadrangular prism long in the right-left direction and has a front surface formed as a flat surface and is configured such that in a sectional shape thereof in a lateral direction, an upper portion of a back surface is formed so as to be narrowed toward above; and
a shim sandwiched between the back surface of the first body and the front surface of the second body,
wherein a liquid reservoir portion in which coating liquid is accumulated is formed in the right-left direction in the back surface of the first body,
the shim has a lower piece arranged on the back surface below the liquid reservoir portion, both right and left pieces arranged on the back surface on both right and left sides of the liquid reservoir portion, and a plurality of comb tooth pieces arranged on the back surface above the liquid reservoir portion and extending in an up-down direction, and
the plurality of comb tooth pieces are fixed to the back surface positioned above the liquid reservoir portion at a predetermined interval.

7. A die for performing stripe coating on a web, comprising:
a first body which is a quadrangular prism long in a right-left direction and has an upper surface formed as a flat surface and is configured such that in a sectional shape thereof in a lateral direction, a front portion of a lower surface is formed so as to be narrowed toward front;
a second body which is a triangular prism long in the right-left direction and has upper and lower surfaces formed as flat surfaces and is configured such that in a sectional shape thereof in a lateral direction, a front portion is formed so as to be narrowed toward the front;
a third body which is a quadrangular prism long in the right-left direction and has a lower surface formed as a flat surface and is configured such that in a sectional shape thereof in a lateral direction, a front portion of an upper surface is formed so as to be narrowed toward the front;
a first shim sandwiched between the upper surface of the first body and the lower surface of the second body; and
a second shim sandwiched between the upper surface of the second body and the lower surface of the third body,
wherein a first liquid reservoir portion in which coating liquid is accumulated is formed in the right-left direction in the upper surface of the first body,
a second liquid reservoir portion in which coating liquid is accumulated is formed in the right-left direction in the upper surface of the second body,
the first shim has a first back piece arranged on the upper surface in back of the first liquid reservoir portion, both first right and left pieces arranged on the upper surface on both right and left sides of the first liquid reservoir portion, and a plurality of first comb tooth pieces arranged on the upper surface in front of the first liquid reservoir portion and extending in a front-back direction,
the plurality of first comb tooth pieces are fixed to the upper surface positioned in front of the first liquid reservoir portion at a predetermined interval,
the second shim has a second back piece arranged on the upper surface in back of the second liquid reservoir portion, both second right and left pieces arranged on the upper surface on both right and left sides of the second liquid reservoir portion, and a plurality of second comb tooth pieces arranged on the upper surface in front of the second liquid reservoir portion and extending in the front-back direction, and
the plurality of second comb tooth pieces are fixed to the upper surface positioned in front of the second liquid reservoir portion at a predetermined interval.
